(19) United States
(12) Patent Application Publication
(10) Pub. No.: US 2014/0331208 A1
(43) Pub. Date: Nov. 6, 2014

(54) COMPUTER AND METHOD FOR DEBUGGING PROGRAM

(71) Applicants: HON HAI PRECISION INDUSTRY CO., LTD., New Taipei (TW); Fu Tai Hua Industry (Shenzhen) Co., Ltd., Shenzhen (CN)

(72) Inventors: FAN LI, Shenzhen (CN); YAO-HUA LIU, Shenzhen (CN); SHIH-FANG WONG, New Taipei (TW); XIN LU, Shenzhen (CN); XIAO-SONG LIU, Shenzhen (CN); QI-DI WU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/951,373

(22) Filed: Jul. 25, 2013

(30) Foreign Application Priority Data
May 3, 2013 (CN) 2013101599398

(51) Int. Cl. G06F 11/36

(52) U.S. Cl. CPC G06F 11/3664
USPC 717/125

(57) ABSTRACT

A computer-implemented method for debugging a program includes responding to user input to debug a program step by step. The debugging information of each line of the program is temporarily stored. Request available stored debugging information is displayed according to user input. Any stored debugging information is deleted when debugging of the program is finished.

### BACKGROUND

1. Technical Field

The present disclosure relates to computers, and particularly to a computer and a method for debugging programs in the computer.

2. Description of Related Art

When debugging a program step by step, if a programmer presses a button (e.g., F10) of a keyboard too soon, which can easily occur when the programmer has been stepping through hundreds of lines, the programmer may miss debugging information of the currently examined line of the program. If this occurs, it is known that current debugging programs do not allow return to a previous step, so the programmer must start the debugging processor again and step through to the line he missed, which decreases the work efficiency.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a computer for debugging a program, in accordance with an exemplary embodiment.

FIG. 2 is a block diagram of a program debugging system of the computer of FIG. 1, in accordance with an exemplary embodiment.

FIG. 3 is a flowchart of a program debugging method, in accordance with an exemplary embodiment.

### DETAILED DESCRIPTION

Embodiments of the present disclosure are described in detail, with reference to the accompanying drawings.

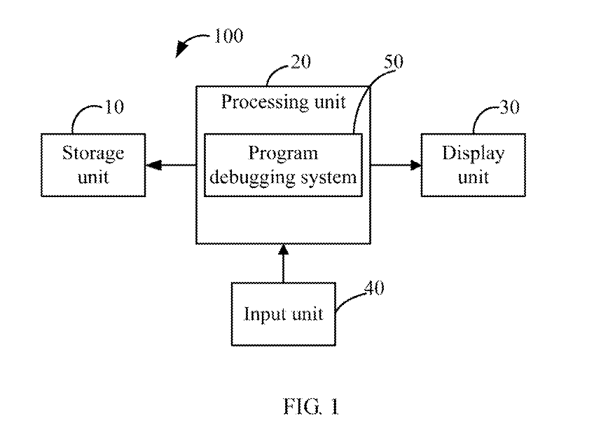

Referring to FIG. 1, an embodiment of a computer 100 includes a storage unit 10, a processing unit 20, a display unit 30, and an input unit 40. The input unit 40 may be a keyboard, or a mouse. The computer 100 further includes a program debugging system 50 stored in the storage unit 10 and executed by the processing unit 20 to debug programs.

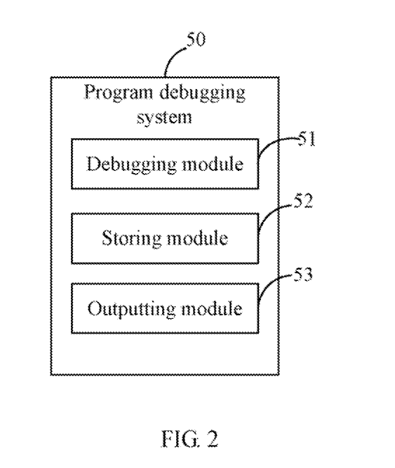

Referring to FIG. 2, the program debugging system 50 includes a debugging module 51, a storing module 52, and an outputting module 53.

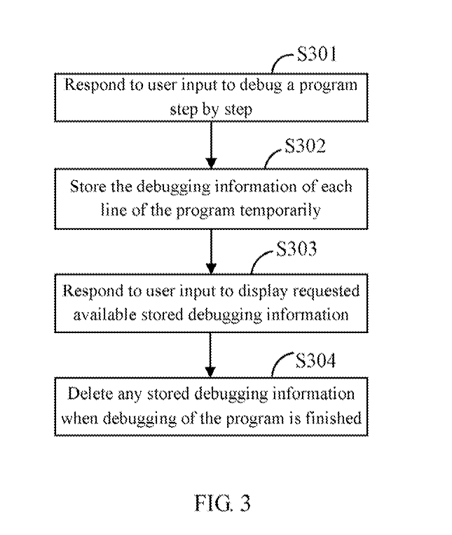

FIG. 3 is a flowchart of a method for debugging a program, in accordance with an exemplary embodiment.

In step S301, the debugging module 51 responds to user input to debug a program step by step.

In step S302, the storing module 52 temporarily stores the debugging information of each line of the program to the storage unit 10. In this embodiment, when n line of the program is debugged, the storing module 52 deletes the debugging information of n−2 line of code of the program, wherein n is equal to or greater than three. That is, the storing module 52 stores the debugging information of the currently examined line of the program and the debugging information of the previous line, so as not to use too much memory. In alternative embodiments, if desired, the storing module 52 may store the debugging information of more than two lines of the program (e. g. ten lines of the program or all lines of the program) to the storage unit 10.

In step S303, the outputting module 53 responds to user input to display requested available debugging information stored in the storage unit 10 on the display unit 30. During debugging the program, when a programmer wants to look up the still available debugging information of a previously debugged line of the program, he/she can depress a button (e.g. a direction button) of the keyboard to call the stored debugging information, stepping through lines in reverse order until the debugging information of a desired line appears. The outputting module 53 outputs an information interface to display the stored debugging information. Thus, while debugging the program, the user can look up the stored debugging information at any time, without debugging the program again.

In step S304, the storing module 52 deletes any stored debugging information when the debugging module 51 finishes debugging the program.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A computer comprising:
one or more processors; and
a storage unit having instructions stored thereon which when executed by the one or more processors, cause the one or more processors to perform operations for debugging a program, the operations comprising:
responding to user input to debug a program step by step;
storing the debugging information of each line of the program to the storage unit temporarily; and
responding to user input to display requested available debugging information stored in the storage unit.

2. The computer as described in claim 1, wherein the operations further comprising:
deleting any stored debugging information when debugging of the program is finished.

3. The computer as described in claim 2, wherein when n line of the program is debugged, the debugging information of n−2 line of the program is deleted from the storage unit, where n is equal to or greater than three.

4. A computer-implemented method for debugging a program, comprising:
responding to user input to debug a program step by step;
storing the debugging information of each line of the program temporarily; and
responding to user input to display requested available stored debugging information.

5. The method as described in claim 4, further comprising:
deleting any stored debugging information when debugging of the program is finished.

6. The method as described in claim 5, wherein when n line of the program is debugged, the debugging information of n−2 line of the program is deleted, where n is equal to or greater than three.

7. A computer storage medium encoded with a computer program, the program comprising instructions that when executed by one or more computers cause the one or more computers to perform operations of debugging a program, the operations comprising:
responding to user input to debug a program step by step;
storing the debugging information of each line of the program temporarily; and
responding to user input to display requested available stored debugging information.

8. The storage medium as described in claim 7, wherein the operations further comprising:
deleting all the stored debugging information when debugging of the program is finished.

9. The storage medium as described in claim 8, wherein when n line of the program is debugged, the debugging information of n−2 line of the program is deleted where n is equal to or greater than three.
